(19) United States
(12) Patent Application Publication
(10) Pub. No.: US 2019/0379260 A1
(43) Pub. Date: Dec. 12, 2019

(54) ANGULAR POSITION SENSING DEVICE

(71) Applicant: HIWIN MIKROSYSTEM CORP., Taichung City (TW)

(72) Inventors: MING-FU TSAI, TAICHUNG CITY (TW); WEI-TE CHUANG, TAICHUNG CITY (TW); CHIA-HSIANG LIEN, TAICHUNG CITY (TW); ZHE-WEI ZHANG, TAICHUNG CITY (TW)

(21) Appl. No.: 16/002,284

(22) Filed: Jun. 7, 2018

(51) Int. Cl. H02K 11/21; H02K 1/14; H02K 3/18; H02K 3/52

(52) U.S. Cl. CPC H02K 11/21; H02K 3/521; H02K 3/18; H02K 1/14

(57) ABSTRACT

An angular position sensing device for detecting angular position of a rotor of a motor includes a first resolver that includes an annular rotor, an annular stator, a plurality of excitation coils and four induction coils. The annular stator has a stator annular body, and a plurality of stator magnetic poles. One of the annular rotor and the annular stator surrounds the other one of the annular rotor and the annular stator. The excitation coils are respectively wound on the stator magnetic poles of the annular stator. The induction coils are respectively wound on four of the stator magnetic poles.

### FIELD

The disclosure relates to a position sensing device, and more particularly to an angular position sensing device for detecting angular position of a rotor of a motor.

### BACKGROUND

U.S. Pat. No. 5,189,353 discloses a conventional angular position sensing device for detecting angular position of a rotor of a motor. The conventional angular position sensing device includes a first resolver, a second resolver, two 3-phase-to-2-phase converters that are respectively coupled to the first and second resolvers, and a processer. Each of the first and second resolvers includes an annular stator that has a plurality of stator magnetic poles. Each of the stator magnetic poles is wound by an excitation coil and an induction coil. Due to the configuration of the stator magnetic poles of each of the first and second resolvers, the first resolver generates a 3-phase first inductive signal that is related to the absolute position of the rotor of the motor, and the second resolver generates a 3-phase second inductive signal that is related to the relative position of the rotor of the motor. To resolve the angular position of the rotor of the motor, the 3-phase-to-2-phase converters respectively receive the 3-phase signals generated by the first and second resolvers, and respectively convert the 3-phase signals into two 2-phase signals. Then, the processor resolves the angular position of the rotor of the motor according to the 2-phase signals generated by the 3-phase-to-2-phase converters.

Since the 3-phase-to-2-phase converters are necessary components of the conventional angular position sensing device due to the configuration of the stator magnetic poles of each of the first and second resolvers, the conventional angular position sensing device may have a relatively complex circuit, and may be relatively costly.

### SUMMARY

Therefore, an object of the disclosure is to provide an angular position sensing device that can alleviate at least one of the drawbacks of the prior art.

According to the disclosure, the angular position sensing device for detecting angular position of a rotor of a motor includes a first resolver that is operable to generate a sine inductive signal and a cosine inductive signal. The sine inductive signal and the cosine inductive signal are related to the absolute angular position of the rotor. The first resolver includes an annular rotor, an annular stator, a plurality of excitation coils and four induction coils. The annular stator has a stator annular body, and a plurality of stator magnetic poles disposed on the stator annular body and angularly and equidistantly spaced apart from each other. One of the annular rotor and the annular stator surrounds the other one of the annular rotor and the annular stator. The excitation coils are respectively wound on the stator magnetic poles of the annular stator, and are close to the stator annular body of the annular stator. The induction coils are respectively wound on four of the stator magnetic poles. Each of the induction coils is distal from the stator annular body of the annular stator, and is spaced apart from the corresponding excitation coil. The magnitude of each of the sine inductive signal and the cosine inductive signal is at least related to the shape of the annular rotor.

### BRIEF DESCRIPTION OF THE DRAWINGS

Other features and advantages of the disclosure will become apparent in the following detailed description of the embodiments with reference to the accompanying drawings, of which:

FIG. 1 is a top view illustrating a first resolver of a first embodiment of the angular position sensing device according to the disclosure;

FIG. 2 is a side view illustrating the first resolver;

FIG. 3 is a top view illustrating a second resolver of the first embodiment;

FIG. 4 shows oscillograms of a sine inductive signal and a cosine inductive signal generated by the first resolver;

FIG. 5 shows oscillograms of a sine inductive signal and a cosine inductive signal of a 2-phase inductive signal generated by the second resolver;

FIG. 6 is a top view illustrating a first resolver of a second embodiment of the angular position sensing device according to the disclosure; and

FIG. 7 is a top view illustrating a first resolver of a third embodiment of the angular position sensing device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

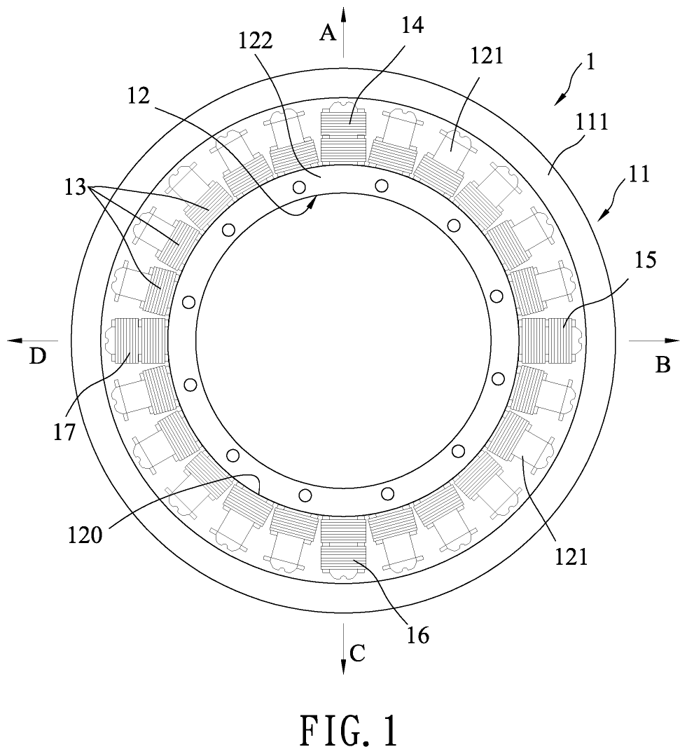

Referring to FIGS. 1 to 3, a first embodiment of an angular position sensing device according to the disclosure is adapted for detecting angular position of a rotor (not shown) of a motor (not shown), and includes a first resolver 1, a second resolver 2 and a signal processor (not shown). The motor may be configured as a direct drive motor.

The first resolver 1 generates a sine inductive signal and a cosine inductive signal, both of which are related to the absolute angular position of the rotor of the motor. In one embodiment, the first resolver 1 includes an annular rotor 11, an annular stator 12, a plurality of excitation coils 13 and four induction coils 14, 15, 16, 17. The magnitude of each of the sine and cosine inductive signals is related to the shape of the rotor 11.

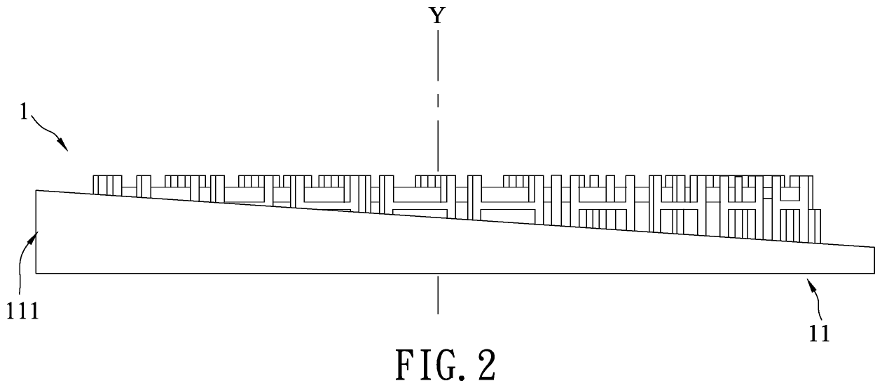

The stator 12 has a stator annular body 122 that has an outer surrounding surface 120 centered at a central axis (Y, see FIG. 2). The rotor 11 has inner and outer surrounding surfaces each of which is centered at the central axis (Y) (i.e., the rotor 11 and the stator 12 are co-axially arranged). The rotor 11 includes a rotor annular body 111. The thickness of the rotor annular body 111 in the direction of the central axis (Y) (i.e., the axial direction of the rotor annular body 111) varies in the circumferential direction of the rotor annular body 111. It should be noted that the rotor 11 of the first resolver 1 is co-axially and co-rotatably coupled to the rotor of the motor. Preferably, the rotor annular body 111 has a thickest portion that has a maximum thickness, and the thickness of the rotor annular body 111 decreases in the circumferential direction away from the thickest portion. In one embodiment, the maximum thickness in the direction of the central axis (Y) is, but is not limited to 10.2 millimeters, and the minimum thickness of the rotor annular body 111 in the direction of the central axis (Y) is, but is not limited to 3.23 millimeters.

The stator 12 further has a plurality of stator magnetic poles 121 that are disposed on the outer surrounding surface 120 and that are angularly spaced apart from each other. Each of the stator magnetic poles 121 is spaced apart from the central axis (Y) by the same distance. One of the rotor 11 and the stator 12 surrounds the other one of the rotor 11 and the stator 12. In one embodiment, the rotor 11 surrounds the stator 12, and the outer surrounding surface 120 of the stator 12 is proximate to the rotor 11.

The excitation coils 13 are respectively wound on the stator magnetic poles 121 of the stator 12, and are close to the outer surrounding surface 120 of the stator 12 (i.e., close to the stator annular body 122). Each of the excitation coils 13 is operable to output an excitation signal.

The induction coils 14, 15, 16, 17 are respectively wound on four of the stator magnetic poles 121 that are angularly and equidistantly spaced apart from each other. Each of the induction coils 14, 15, 16, 17 is located at one side of the corresponding excitation coil 13 distal from the outer surrounding surface 120 of the stator 12 (i.e., distal from the annular body 122), and is spaced apart from the corresponding excitation coil 13. In one embodiment, each of the stator magnetic poles 121 extends in the radial direction of the stator 12, and two adjacent ones of the four stator magnetic poles 121 are perpendicular to each other. For example, the extending direction (A) of the stator magnetic pole 121 on which the induction coil 14 is wound is perpendicular to the extending direction (B) of the stator magnetic pole 121 on which the induction coil 15 is wound. The extending direction (A) is perpendicular to the extending direction (D) of the stator magnetic pole 121 on which the induction coil 17 is wound. The extending direction (C) of the stator magnetic pole 121 on which the induction coil 16 is wound is perpendicular to the extending direction (B). The extending direction (C) and the extending direction (D) are perpendicular to each other. It should be noted that the induction coils 14, 15, 16, 17 detect change of the magnetic field due to rotation of the rotor 11, and output the sine inductive signal and the cosine inductive signal. In one embodiment, the induction coils 15, 17 cooperatively output the sine inductive signal, and the induction coils 14, 16 cooperatively output the cosine inductive signal.

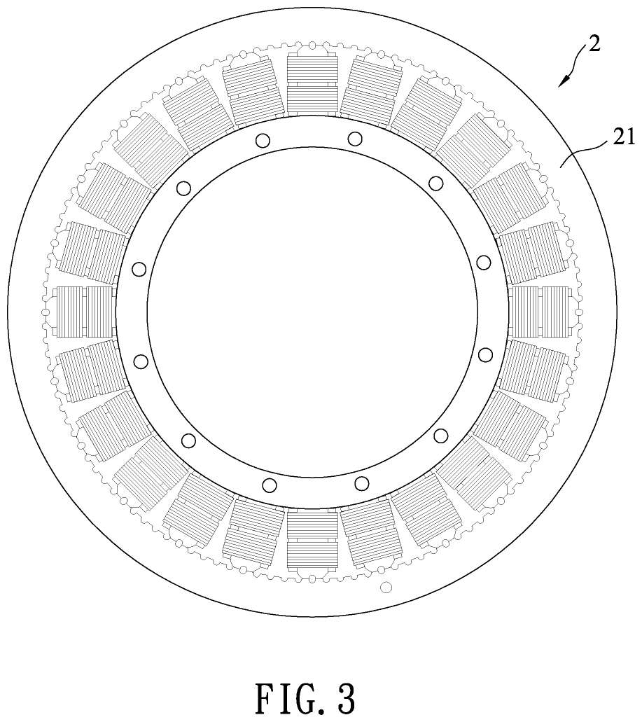

The second resolver 2 (see FIG. 3) generates a 2-phase (i.e., sine and cosine) inductive signal in a known manner. The 2-phase inductive signal generated by the second resolver 2 is related to the relative angular position of the rotor of the motor (i.e., relative to the absolute angular position). In one embodiment, the second resolver 2 has a rotor 21 that is co-axially and co-rotatably coupled to the rotor of the motor. The cooperation among the first resolver 1, the second resolver 2 and the motor is well-known in the art, and wound not be further described in the following paragraphs.

The processor receives the sine and cosine inductive signals generated by the first resolver 1 and the 2-phase inductive signal generated by the second resolver 2, and resolves the angular position of the rotor of the motor accordingly in a known manner.

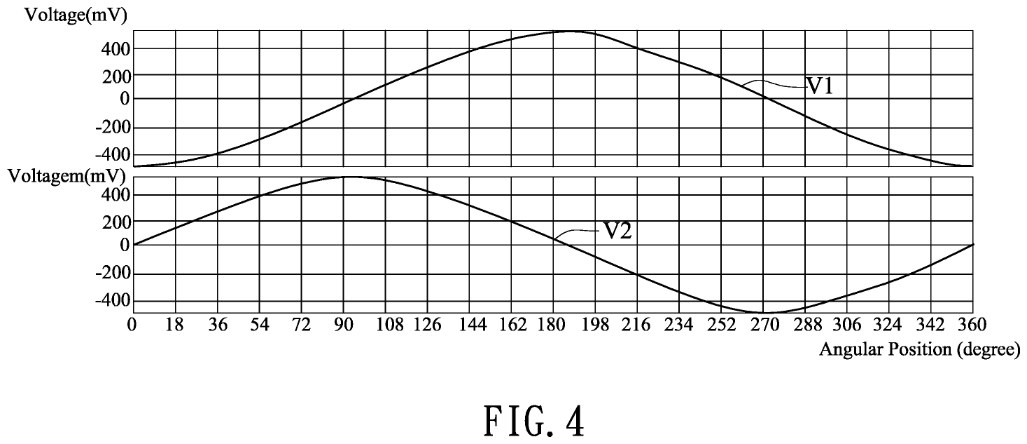

FIG. 4 shows the oscillograms of the sine inductive signal (V1) and the cosine inductive signal (V2) generated by the first resolver 1.

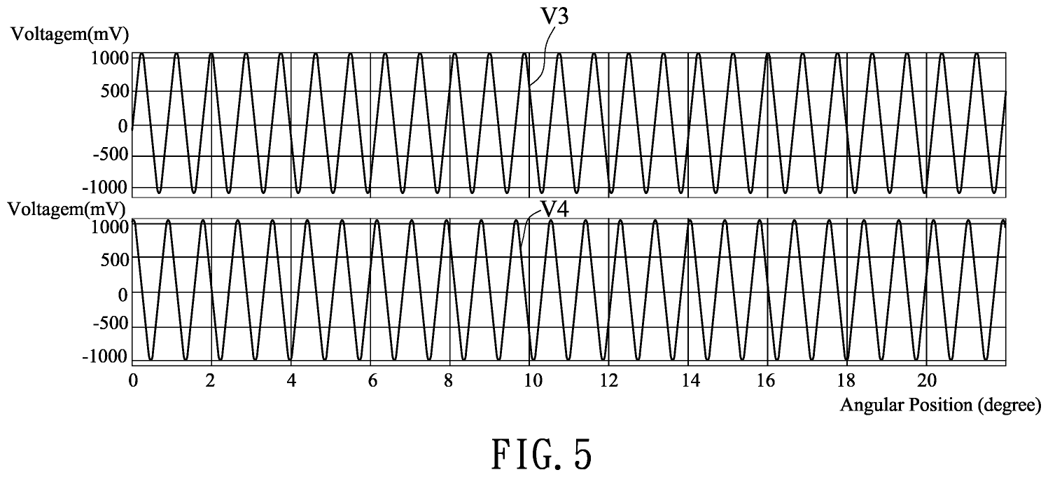

FIG. 5 shows the oscillograms of a sine inductive signal (V3) and a cosine inductive signal (V4) of the 2-phase inductive signal generated by the second resolver 2.

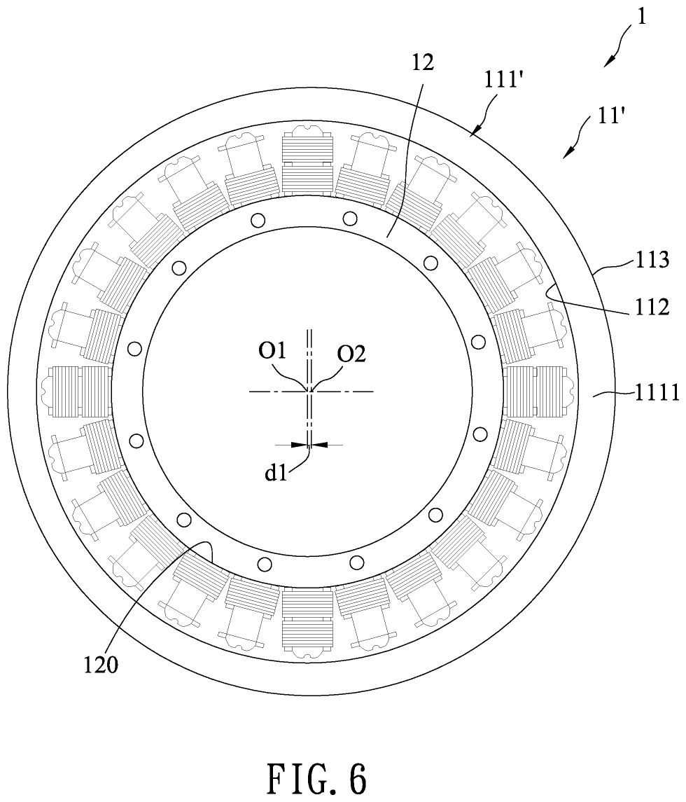

Referring to FIG. 6, a second embodiment of the angular position sensing device according to the disclosure is similar to the first embodiment. The rotor 11′ of the first resolver 1 of the second embodiment has a rotor annular body 111′. The rotor annular body 111′ has an inner surrounding surface 112 that faces the outer surrounding surface 120 of the stator 12 (i.e., proximate to the stator 12), and an outer surrounding surface 113 that faces away from the outer surrounding surface 120 of the stator 12 (i.e., distal from the stator 12). The inner surrounding surface 112 of the rotor annular body 111′ is centered at a first center (O1) at which the outer surrounding surface 120 of the stator 12 is centered. The outer surrounding surface 113 of the rotor annular body 111′ is centered at a second center (O2) that is spaced apart from the first center (O1) by a distance (d1). As such, the thickness of the rotor annular body 111′ in the radial direction varies in the circumferential direction thereof. Preferably, the rotor annular body 111′ has a thickest portion 1111 that has a maximum thickness, and the thickness of the rotor annular body 111′ decreases in the circumferential direction away from the thickest portion 1111. In one embodiment, the maximum thickness in the radial direction is, but is not limited to 7.7 millimeters, and the minimum thickness of the rotor annular body 111′ in the radial direction is, but is not limited to 6.5 millimeters.

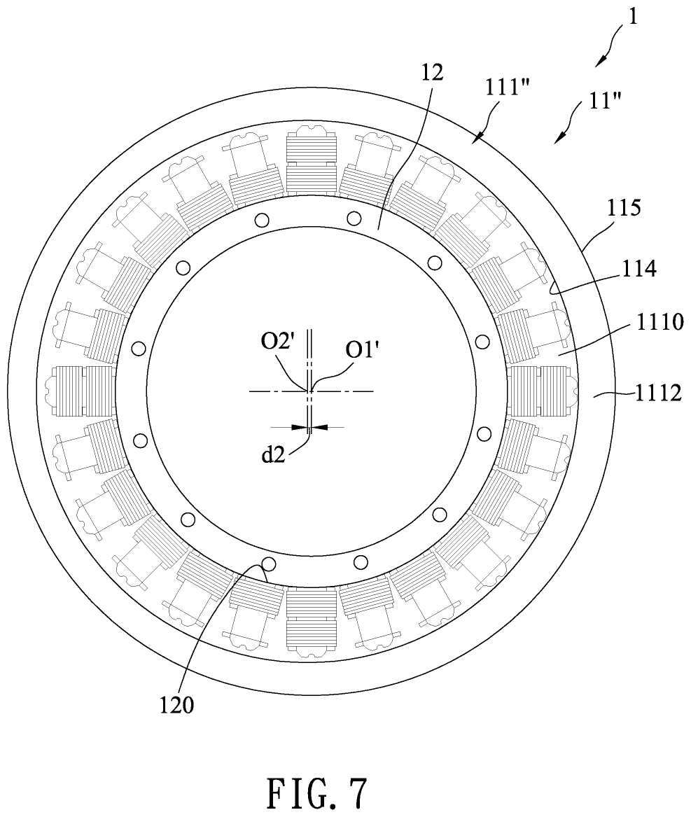

Referring to FIG. 7, a third embodiment of the angular position sensing device according to the disclosure is similar to the first embodiment. The rotor 11″ of the first resolver 1 of the third embodiment has a rotor annular body 111″. The rotor annular body 111″ has an inner surrounding surface 114 that faces the outer surrounding surface 120 of the stator 12, and an outer surrounding surface 115 that faces away from the outer surrounding surface 120 of the stator 12. The magnitude of each of the sine and cosine inductive signals is related to the shape of the rotor 11″ and the relative position between the inner surrounding surface 114 of the rotor annular body 111″ and the outer surrounding surface 120 of the stator 12.

In one embodiment, the outer surrounding surface 115 of the rotor annular body 111″ is centered at a first center (O1′) at which the outer surrounding surface 120 of the stator 12 is centered. The inner surrounding surface 114 of the rotor annular body 111″ is centered at a second center (O2′) that is spaced apart from the first center (O1′) by a distance (d2). As such, the thickness of the rotor annular body 111′ in the radial direction varies in the circumferential direction thereof, and an annular gap 1110 defined between the inner surrounding surface 114 of the rotor annular body 111″ and the outer surrounding surface 120 of the stator 12 has a width varying in the circumferential direction thereof. Preferably, the rotor annular body 111″ has a thickest portion 1112 that has a maximum thickness, and the thickness of the rotor annular body 111″ decreases in the circumferential direction away from the thickest portion 1112. The annular gap 1110 has a minimum width at the proximity of the thickest portion 1112. The width of the annular gap 1110 increases in the circumferential direction away from the thickest portion 1112. In one embodiment, the maximum thickness in the radial direction is, but is not limited to 7.7 millimeters, and the minimum thickness of the rotor annular body 111″ in the radial direction is, but is not limited to 6.5 millimeters.

In summary, since the first resolver 1 generates a 2-phase inductive signal (i.e., a combination of the sine inductive signal and the cosine inductive signal) by virtue of the arrangement of the induction coils 14, 15, 16, 17 of the first resolver 1, and since the second resolver 2 generates a 2-phase inductive signal, the processor directly resolves the angular position of the rotor of the motor upon reception of the sine and cosine inductive signals generated by the first resolver 1 and the 2-phase inductive signal generated by the second resolver 2 without additional 3-phase-to-2-phase converter. Therefore, the angular position sensing device according to the disclosure has a relatively simple circuit and a relatively low cost.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An angular position sensing device adapted for detecting angular position of a rotor of a motor comprising:
a first resolver operable to generate a sine inductive signal and a cosine inductive signal, the sine inductive signal and the cosine inductive signal being related to the absolute angular position of the rotor, said first resolver including
an annular rotor,
an annular stator that has a stator annular body, and a plurality of stator magnetic poles disposed on said stator annular body and angularly spaced apart from each other, each of said stator magnetic poles being spaced apart from a central axis of said annular stator by the same distance, one of said annular rotor and said annular stator surrounding the other one of said annular rotor and said annular stator,
a plurality of excitation coils that are respectively wound on said stator magnetic poles of said annular stator and that are close to said stator annular body of said annular stator, and
four induction coils that are respectively wound on four of said stator magnetic poles, each of said induction coils being distal from said stator annular body of said annular stator, and being spaced apart from said corresponding excitation coil;
wherein the magnitude of each of the sine inductive signal and the cosine inductive signal is at least related to the shape of said annular rotor.

2. The angular position sensing device as claimed in claim 1, wherein two adjacent ones of said four stator magnetic poles on which said induction coils are respectively wound respectively extend in two directions that are perpendicular to each other.

3. The angular position sensing device as claimed in claim 1, wherein said annular rotor and said annular stator are co-axially arranged, said annular rotor having a rotor annular body, the thickness of said rotor annular body in the axial direction of said rotor annular body varying in the circumferential direction of said rotor annular body, said rotor annular body having a thickest portion that has a maximum thickness, the thickness of said rotor annular body decreasing in the circumferential direction away from said thickest portion.

4. The angular position sensing device as claimed in claim 1, wherein said annular rotor surrounds said annular stator, said stator annular body of said annular stator having an outer surrounding surface that faces said annular rotor, said stator magnetic poles being disposed on said outer surrounding surface of said stator annular body of said annular stator.

5. The angular position sensing device as claimed in claim 4, wherein said annular rotor has a rotor annular body, said rotor annular body having an inner surrounding surface that is proximate to said outer surrounding surface of said stator annular body of said annular stator, and an outer surrounding surface that is distal from said outer surrounding surface of said stator annular body of said annular stator, said inner surrounding surface of said rotor annular body being centered at a first center at which said outer surrounding surface of said annular stator is centered, said outer surrounding surface of said rotor annular body being centered at a second center that is spaced apart from the first center by a distance, such that the thickness of said rotor annular body in the radial direction varies in the circumferential direction thereof, said rotor annular body having a thickest portion that has a maximum thickness, the thickness of said rotor annular body decreasing in the circumferential direction away from said thickest portion.

6. The angular position sensing device as claimed in claim 4, wherein said annular rotor has a rotor annular body, said rotor annular body having an inner surrounding surface that is proximate to said outer surrounding surface of said stator annular body of said annular stator, and an outer surrounding surface that is distal from said outer surrounding surface of said stator annular body of said annular stator, the magnitude of each of the sine and cosine inductive signals being related to the shape of said annular rotor and the relative position between said inner surrounding surface of said rotor annular body and said outer surrounding surface of said stator.

7. The angular position sensing device as claimed in claim 6, wherein said outer surrounding surface of said rotor annular body being centered at a first center at which said outer surrounding surface of said annular stator is centered, said inner surrounding surface of said rotor annular body being centered at a second center that is spaced apart from the first center by a distance, such that the thickness of said rotor annular body in the radial direction varies in the circumferential direction thereof, and that an annular gap defined between said inner surrounding surface of said rotor annular body and said outer surrounding surface of said stator has a width varying in the circumferential direction thereof, said rotor annular body having a thickest portion that has a maximum thickness, the thickness of said rotor annular body decreasing in the circumferential direction away from said thickest portion, said annular gap having a minimum width at the proximity of said thickest portion, the width of said annular gap increasing in the circumferential direction away from said thickest portion.
